(19) United States
(12) Patent Application Publication
(10) Pub. No.: US 2006/0136190 A1
(43) Pub. Date: Jun. 22, 2006

(54) Method of evaluating system performance

(75) Inventor: Kohsaku Shibata, Takatsuki-shi (JP)

Correspondence Address: STEPTOE & JOHNSON LLP, 1330 CONNECTICUT AVE., NW, WASHINGTON, DC, 20036, US

(73) Assignee: Matsushita Electric Industrial Co., Ltd., Kadoma-shi (JP)

(21) Appl. No.: 11/300,325

(22) Filed: Dec. 15, 2005

(30) Foreign Application Priority Data
Dec. 17, 2004 (JP) 2004-365185

(51) Int. Cl. G06F 9/45

(52) U.S. Cl. 703/22

(57) ABSTRACT

The system performance evaluation method of the present invention confirms the existence of the occurrence of a memory access penalty for each cycle (S101) and executes a CPU model only when a memory access penalty has not occurred (S202).

### BACKGROUND OF THE INVENTION

1. Field of the Invention

The present invention relates to a technology for evaluating system performance for evaluating the performance of a system such as a system LSI, provided with a CPU and a memory.

2. Description of the Related Art

Conventionally, in system development in the field of device integration, a process that verifies whether the desired performance has been satisfied by using a system simulator that operates on a computer prior to integration of the actual system is very important.

Therefore, in recent years, systems that undergo simulation by means of a system simulator have often comprised a CPU (data processing device) and a memory (storage area). Normally, in order to solve the trade-off between speed and cost, a hierarchical structure comprising a cache system and so forth for caching data has been adopted for the memory, and this hierarchical structure has a huge influence on the performance of the system.

Therefore, as shown in FIG. 22, many system simulators comprise a CPU model and a memory hierarchy model.

The conventional typical system simulator 2201 shown in FIG. 22 is a simulator that simulates the operation of the device integration system.

The system simulator 2201 comprises a CPU model 2204 that simulates the CPU mounted in the device integration system and a memory model 2205 that simulates the memory hierarchy constructed on the device integration system. Further, the system simulator 2201 comprises a scheduling portion 2202 that controls the execution order and so forth of the CPU model 2204 and memory model 2205. In addition, the scheduling portion 2202 contains an execution cycle number counting portion 2203 that counts the cycles in which simulation is performed.

The scheduling portion 2202 executes a model execution processing step S200 by means of the flow shown in FIG. 21. The model execution processing step S200 comprises a memory model execution step S201 that executes one cycle's worth of the memory model 2205, a CPU model execution step S202 that executes one cycle's worth of the CPU model 2204, an execution cycle number increment step S203 that increments the execution cycle number that is saved in the execution cycle number counting portion 2203 and a termination condition judgment step S204 of judging whether the state of the simulation matches the termination condition.

As shown in FIG. 21, the model execution processing step S200 executes one cycle's worth of the memory model execution step S201 and CPU model execution step S202 in parallel. Thereafter, the execution cycle number is incremented in the execution cycle number increment step S203.

Thereafter, the simulation state is evaluated in the termination condition judgment step S204 and, if the simulation state does not conform to the termination condition, the simulation is continued. If the simulation state conforms to the termination condition, the model execution processing step S200 is terminated.

In the case of the conventional method with the configuration above, a system simulation is performed to measure the performance of the system while reflecting the simulation result of the memory hierarchy in the CPU simulation.

However, it is not possible to specify whether there is a bottleneck in the system performance for both the CPU performance and memory performance simply by measuring the system performance. Therefore, the CPU performance is computed by totaling the memory access penalty (overhead time due to memory access) that occurs during system simulation and taking the differential of the execution time of the whole system and the memory access penalty.

However, there has been the possibility of overvaluing the CPU performance found in this manner. This will be described hereinafter by using FIGS. 16, 17, and 18.

FIG. 16 is a block diagram showing the configuration of a CPU mounted in a conventional device integration system. In FIG. 16, a CPU 4100 is connected to an instruction cache 4151 and data cache 4152 that cache the data of the external memory and, when data that has not been cached is requested, the requested data cannot be used until the memory data arrives.

Furthermore, the CPU 4100 comprises a variety of pipeline stages delimited by a pipeline register and a register file 4121 that saves the context. The various pipeline stages of the CPU 4100 comprise an IF stage 4101 that fetches instructions, a DC stage 4102 that decodes the fetched instructions, an EX stage 4103 that executes the decoded instructions, a MEM stage 4104 that executes memory access by means of the executed instructions, a WB stage 4105 that changes the register file 4121 by means of the executed instructions, and a DIV1 stage 4111, DIV2 stage 4112, and DIV3 stage 4113 that perform division.

The respective pipeline stages operate in parallel, are capable of processing instructions one by one in each stage, and simultaneously process a plurality of instructions overall.

The execution states of the pipeline stages at a certain point in time are shown in FIGS. 17 and 18.

FIG. 17 is a time chart that shows with which pipeline of the CPU 4100 the four instructions shown on the left on the vertical axis are processed at each time. The vertical axis represents the executed instructions among the instructions in order from the top and the horizontal axis represents the time of the system simulation.

The four instructions in FIG. 17 serve to instruct the CPU 4100 to execute processing on the basis of the operations illustrated below (the correspondence between the instructions and the operations of the instructions appears as ‘instruction: operation’).

DIV R0, R1: the value of register 0 is divided by the value of register 1 and the quotient is stored in register 0;

LD R2, (R3): the memory data of the address stored in the register 3 is read and stored in the register 2;

ADD R4, R0: the sum of the value of register 4 and the value of register 0 is stored in register 4;

MOV R5, R6: the value of register 6 is stored in register 5.

Each of these four instructions is fetched from the instruction memory in the order mentioned above. That is, at time T100, the DIV instruction fetch is started. The execution of the DIV instruction is performed in the DIV1 stage 4111 to DIV3 stage 4113. The ADD instruction that succeeds the DIV instruction executes computation processing by using the computation result of the DIV instruction.

The relationship between the DIV instruction and ADD instruction is known as data dependency. In the illustrated case where data dependence exists, the execution of the subsequent instruction (the ADD instruction in FIG. 17) that uses the computation result of the previous instruction (DIV instruction in FIG. 17) awaits the end of the execution of the previous instruction. As a result, a pipeline stall due to data dependence between instructions occurs as shown in FIG. 17.

As detailed above, in the simulation to evaluate CPU performance, when there is a drop in the execution performance arising from the pipeline stall that occurs due to the data dependence between instructions, if this pipeline stall is not correctly reproduced, the high performance is measured by means of the original CPU performance without consideration of the drop in execution performance. For example, in a state where a memory access penalty as shown in FIG. 17 has not occurred, the instruction execution time from the DIV instruction to the MOV instruction is nine cycles from time T100 to time T101. A case where instructions like those in FIG. 17 are executed under the condition that the memory access penalty be dependent will be described next by using FIG. 18.

As per FIG. 17, FIG. 18 is a time chart illustrating which pipelines of CPU 4100 the four instructions illustrated on the left on the vertical axis are processed by at each time. The vertical axis represents the order from the top of the executed instructions of the instructions and the horizontal axis represents the time of the simulation of the system.

In the case of the LD instruction in FIG. 18, a memory access penalty occurs in three cycles. The LD instruction awaits the arrival of data in order to read memory data in the MEM stage and, therefore, three cycles' worth of pipeline stalls are caused to occur. Here, the DIV instruction preceding the LD instruction terminates the execution and, in the case of the ADD instruction and MOV instruction, a pipeline stall due to data dependence between instructions as illustrated in FIG. 17 does not occur.

In the state of FIG. 18, the instruction execution time from the DIV instruction to the MOV instruction is eleven cycles from time T110 to time T111. Thereupon, the memory access penalty is three cycles. Here, when the instruction execution time of the CPU in a case where the memory access penalty is 0 is calculated by using the above method as the conventional method, eight cycles, which are rendered by subtracting three cycles' worth of the memory access penalty from the eleven cycles of the instruction execution time, are produced. However, as indicated in the description of FIG. 17, the instruction execution time of the CPU in a case where the memory access penalty is 0 is 9 cycles.

As mentioned earlier, when the instruction execution time of the CPU rendered by removing the effect of the memory access penalty is computed by using conventional methods, the performance of the CPU is overvalued and, therefore, as a conventional countermeasure to this overvaluation, a system simulation environment rendered by removing an overhead pertaining to the memory hierarchy is additionally prepared and the genuine CPU performance is measured by using the system simulation environment to measure the effects on performance of the memory hierarchy.

However, with such a method, the simulation of the system is performed twice and there is the problem that the simulation time is extended. Moreover, there is also the problem of production costs for preparing two different simulation environments and errors resulting from the difference in conditions.

On the other hand, for a few conventional system performance evaluation methods, a method that isolates the CPU simulation and the simulation of the memory hierarchy in order to efficiently simulate the memory hierarchy as detailed in Japanese Koho Application Laid Open No. 2000-276381 (P 16, FIG. 1), for example, has been considered.

With this method, the system performance evaluation is performed efficiently by outputting the memory access log from the simulation results of the CPU and executing the cache simulation by using the outputted memory access log.

However, in conventional system performance evaluation methods as mentioned above, because software in the device integration field of recent years has grown complicated and the number of instructions executed by the system has rapidly increased, when there is a desire to accurately evaluate the CPU performance of the system by using the above method, the memory access log of the CPU is huge and there has been the problem that a huge disk capacity is therefore required.

### SUMMARY OF THE INVENTION

The present invention solves the conventional problems above and provides a method of evaluating system performance that allows it to accurately evaluate CPU performance in a case where the memory access penalty is 0, even with a small disk capacity, while performing a simulation of the memory hierarchy, and to correctly evaluate the performance even for a larger-scale system.

In order to solve this problem, a first invention is a system performance evaluation method for evaluating the performance of a system comprising at least one CPU and memory hierarchy. The method comprises a CPU simulation step of executing a simulation of the CPU, a memory simulation step of executing a simulation of the memory hierarchy, a system simulation step of executing the CPU simulation step and the memory simulation step in parallel, a CPU performance measurement step of measuring the performance of the CPU from which the effect of the memory hierarchy is removed, and a system performance measurement step of measuring a performance deterioration of the system caused by the effect of the memory hierarchy.

As detailed above, because the performance of the CPU unit and the deterioration in the performance due to the memory hierarchy is calculated separately from the calculation of the system performance while performing a simulation of the whole system, there is no need to save a massive memory access log and the performance of the CPU unit and the performance deterioration due to the memory hierarchy can be grasped by means of one system simulation.

Further, the second invention comprises the steps of the first invention, and further comprises a penalty occurrence judgment step of judging whether or not a memory access penalty has occurred in the memory simulation step, and a CPU simulation skip step of skipping the CPU simulation step when a memory access penalty has occurred as a result of the judgment in the penalty occurrence judgment step, wherein in the CPU performance measurement step, the CPU performance is measured based on the number of cycles in which the CPU simulation is finally executed as a result of skipping the CPU simulation step in the CPU simulation skip step.

As detailed above, by performing a system simulation without the effect of the memory access penalty being reflected in the CPU simulation, a state where the memory access penalty is 0 in the CPU simulation can be preserved and the performance of the CPU unit with the effect of the memory access penalty removed can be accurately measured.

Further, the third invention is a method that comprises the steps of the second invention, and further comprises a memory access simulation step that executes a simulation of only the memory access in the CPU simulation step, and a simulation selection step of executing the memory access simulation step when the memory access penalty has not occurred as a result of the penalty occurrence judgment step.

As detailed above, by performing a system simulation to satisfy the memory access protocol between the CPU and memory hierarchy, the communication protocol between the CPU of an existing simulator and the memory can be satisfied and the simulation can be applied by means of small changes to the existing simulator.

Further, the fourth invention is a method that comprises the steps of the third invention, and further comprises a simulation mode selection step of specifying whether or not the effect of the memory access penalty is reflected when executing the CPU simulation step.

As detailed above, because the decision whether or not to perform a simulation to substitute the input/output processing that the CPU is to perform on the memory hierarchy can be changed, two applications can be satisfied by means of one simulator when it is verified what kind of effect the memory access penalty has on the operation of the CPU and when the performance of the CPU is to be estimated at the same time as the system performance.

Further, the fifth invention is a system performance evaluation method that comprises, as a system simulation for evaluating the performance of a system comprising at least one CPU and memory hierarchy, a step of executing a calculation of the number of instruction execution cycles on the CPU when the effect of the memory hierarchy is removed. The method further comprises an instruction cache hit rate judgment step of judging, in accordance with a hit rate value of an instruction cache memory, simulation errors in the results of calculation of the number of instruction execution cycles on the CPU when the effect of the memory hierarchy is reflected in the calculation results, with respect to the calculation results when the effect of the memory hierarchy is removed, and an error display step of displaying the simulation error based on the results of the instruction cache hit rate judgment step.

Furthermore, the sixth invention is a system performance evaluation method that comprises, as a system simulation for evaluating the performance of a system that comprises at least one CPU and memory hierarchy, a step of executing a calculation of the number of instruction execution cycles on the CPU when the effect of the memory hierarchy is removed. The method further comprises a memory access penalty judgment step of judging, in accordance with the value of the memory access penalty, simulation errors in the results of the calculation when the effect of the memory hierarchy is reflected in the calculation results when the effect of the memory hierarchy is removed, with respect to the calculation results when the effect of the memory hierarchy is removed, and an error display step of displaying the simulation error based on the results of the instruction cache hit rate judgment step.

As detailed above, by calculating an index that indicates whether a permissible error occurs in cases where the effect of the memory access penalty is not reflected in the CPU simulation and cases where the effects are reflected, the person performing the system performance evaluation is able to identify to what extent the simulation can be relied upon and is able to avoid performing an erroneous performance evaluation.

According to the present invention as detailed above, it is possible to execute a simulation that measures the overhead caused by the memory hierarchy at the same time while accurately measuring the performance of the CPU without changing the system performance evaluation environment.

Further, resources for saving the memory access trace log are unnecessary, both the CPU performance and system performance can be easily measured at the same time, and the number of instruction execution cycles when the overhead caused by memory access is 0 can be accurately calculated.

As detailed above, efficient development is rendered possible by means of the device integration system. And even with a small disk capacity, the CPU performance when the memory access penalty is 0 can be accurately evaluated while performing a simulation of the memory hierarchy and the performance can be correctly evaluated even for a larger-scale system.

### BRIEF DESCRIPTION OF THE DRAWINGS

FIG. 1 is a flowchart of simulation model execution processing in a system performance evaluation method according to a first embodiment of the present invention;

FIG. 2 is a flowchart of simulation model execution processing in a system performance evaluation method according to a second embodiment of the present invention;

FIG. 3 is a flowchart of memory access alternate processing in the system performance evaluation method according to the first embodiment of the present invention;

FIG. 4 is a flowchart of instruction cache hit rate judgment processing in the system performance evaluation method according to the first embodiment of the present invention;

FIG. 5 is a flowchart of instruction memory access penalty occurrence rate judgment processing in the system performance evaluation method according to the second embodiment of the present invention;

FIG. 6 is a flowchart of instruction cache hit rate judgment processing in the system performance evaluation method according to the first embodiment of the present invention;

FIG. 7 is a flowchart of instruction memory access penalty occurrence rate judgment processing in the system performance evaluation method according to the second embodiment of the present invention;

FIG. 8 is a block diagram showing the configuration of a system simulator in the system performance evaluation method according to the first embodiment of the present invention;

FIG. 9 is a block diagram showing the configuration of a system simulator in the system performance evaluation method according to the second embodiment of the present invention;

FIG. 10 is an explanatory diagram of a display apparatus in the system performance evaluation method according to the first embodiment of the present invention;

FIG. 11 is an explanatory diagram of a display apparatus in the system performance evaluation method according to the second embodiment of the present invention;

FIG. 12 is an explanatory diagram of a display example of the display apparatus in the system performance evaluation method according to the first and second embodiments of the present invention;

FIG. 13 is an external view of the configuration on the system performance evaluation method according to the first and second embodiments of the present invention;

FIG. 14 is a waveform diagram showing signals that are exchanged between the CPU and memory in the system performance evaluation method according to the first embodiment of the present invention;

FIG. 15A is a signal waveform diagram in a case where storage of data is requested from a CPU model to a memory model and the memory model receives the storage request after three cycles, in the system performance evaluation method according to the first embodiment of the present invention;

FIG. 15B is a signal waveform diagram in a case where the CPU model is caused to operate only when there is no memory access penalty, in the system performance evaluation method according to the first embodiment of the present invention;

FIG. 16 is a block diagram showing the performance of the CPU in a conventional system performance evaluation method;

FIG. 17 is a time chart showing the relationship between instructions processed by the CPU and pipeline stages, in the same conventional system performance evaluation method;

FIG. 18 is another time chart showing the relationship between instructions processed by the CPU and pipeline stages, in the same conventional system performance evaluation method;

FIG. 19 is a time chart showing the relationship between instruction access which is executed by the simulation model of the CPU, and instruction execution, in the system performance evaluation method according to the first embodiment of the present invention;

FIG. 20 is another time chart showing the relationship between instruction access which is executed by the simulation model of the CPU, and instruction execution, in the system performance evaluation method according to the first embodiment of the present invention;

FIG. 21 is a flowchart of simulation model execution processing in a conventional system performance evaluation method; and

FIG. 22 is a block diagram showing the configuration of a system simulator in the same conventional system performance evaluation method.

### DESCRIPTION OF THE PREFERRED EMBODIMENTS

The system performance evaluation method according to embodiments of the present invention will be described specifically hereinbelow with reference to the drawings.

### First Embodiment

The system performance evaluation method of the first embodiment of the present invention will now be described.

First, the appearance of the system performance evaluation system relating to the system performance evaluation method of the first embodiment will be described.

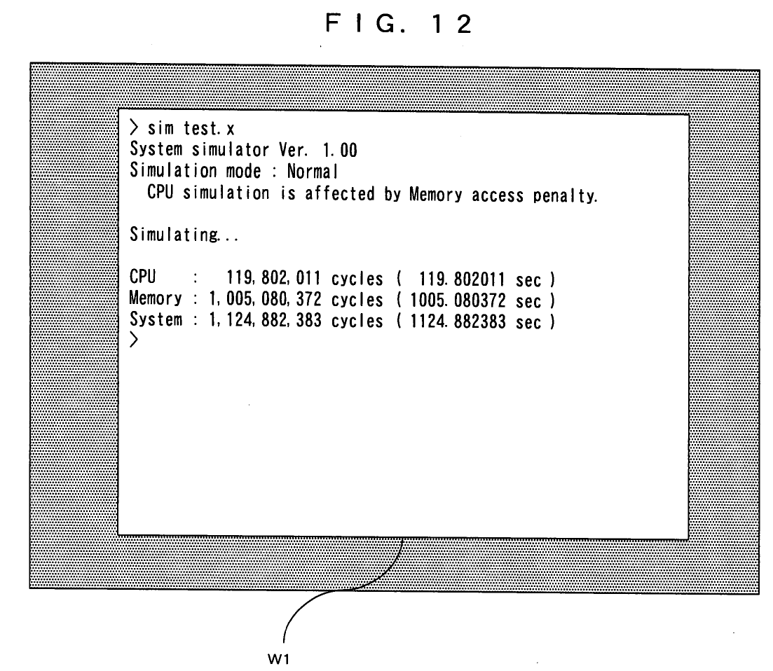

FIG. 13 shows the appearance of the system performance evaluation system 1100 of the first embodiment. The system performance evaluation system 1100 of the first embodiment comprises a computer 1101, a display device 1102, and an input device 1103 such as a keyboard.

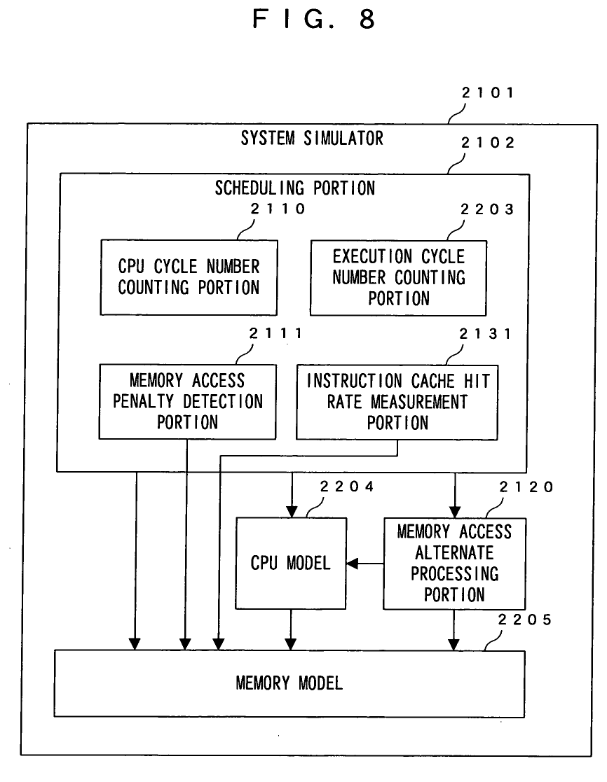

In the system performance evaluation system 1100 above, when the system is simulated in order to evaluate the performance of the system, a system simulation program that the system simulator 2101 shown in FIG. 8 comprises is executed by the computer 1101.

Thereupon, the user of the system performance evaluation system 1100 supplies an instruction to the computer 1101 by using the input device 1103 and, by simulating the system subject to the evaluation in accordance with the supplied instruction, the computer 1101 displays the performance of the target system on the display device 1102 as a result of the simulation.

The input/output of the system performance evaluation system 1100 relating to the system performance evaluation method of the first embodiment will be described next.

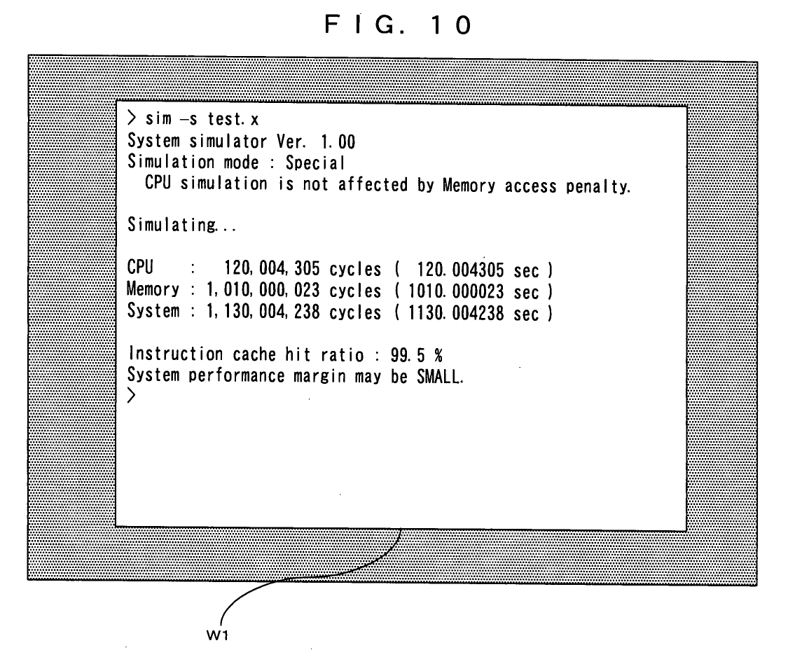

FIGS. 10 and 12 are input/output examples with respect to the system performance evaluation system 1100 of the first embodiment, which is content displayed on the display device 1102. Commands and command results inputted by the console and user are displayed on a main window W1.

The content displayed on FIG. 10 will now be described in detail.

‘>’ in FIG. 10 is a prompt of the console and the user inputs a command by means of the input device 1103 in each row in which ‘>’ is displayed to control the computer 1101. In FIG. 10, the user inputs a command such as ‘sim -s test. x’. The sim command is a command that executes the program of the system simulator 2101. -s is an option that instructs the system simulator 2101 not to reflect the effect of the memory access penalty in the CPU simulation. test. x is the file name of the program of the device integration system that is loaded in the system simulator 2101.

As shown in FIG. 10, upon receipt of the sim command, the computer 1101 executes a simulation by activating the system simulator 2101 and, after executing the simulation, the user displays the simulation result and returns to a command standby state to await a command from the user.

The row ‘System:’ in FIG. 10 shows the program execution cycle number of the simulated system and the execution time. In FIG. 10, this is shown to be 1,130,004,238 cycles (1130.004238 seconds). These values are values that are saved in the CPU cycle number count portion 2110 shown in FIG. 8 (described subsequently).

The row ‘Memory:’ in FIG. 10 shows the number of cycles which are totaled as the memory access penalty, and the time. In FIG. 10, this is shown to be 1,010,000,023 cycles (1010.000023 seconds).

The row ‘CPU:’ in FIG. 10 indicates the program execution cycle number when the memory access penalty is 0 and the execution time. In FIG. 10, this is shown to be 120,004,305 cycles (120.004305 seconds).

The row ‘Instruction cache hit ratio:’ shows the hit rate of the instruction cache. FIG. 10 shows that, of the total instruction memory access, 99.5% of the instruction memory access hits the instruction cache.

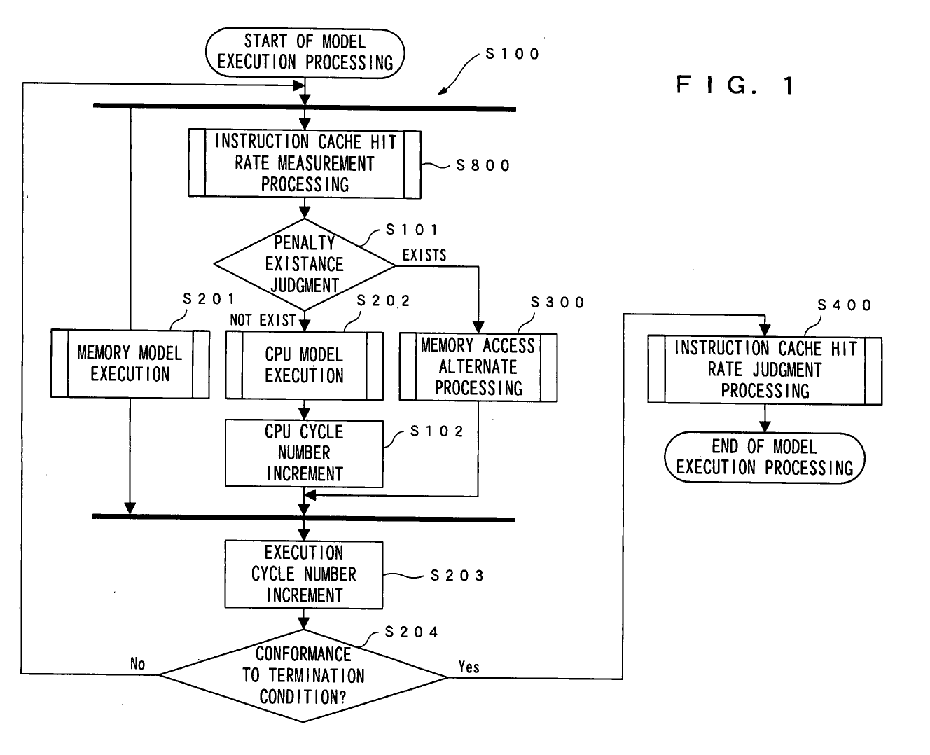

The row ‘System Performance’ in FIG. 10 is a message indicating whether the margin for the program execution cycle number of the simulated system and the execution time is small. In FIG. 10, the margin for the program execution cycle number of the simulated system and the execution time is probably small. The judgment of whether the program execution cycle number of the simulated system and the execution time is small is made by means of the instruction cache hit rate judgment processing step S400 shown in FIG. 1 (described subsequently).

FIG. 12 shows only differences from FIG. 10.

In FIG. 12, the user inputs a command such as ‘sim test.x’. The fact that there is no option -s of the sim command differs from the case in FIG. 10. In this case, the system simulator 2101 performs a system simulation by reflecting the effect of the memory access penalty in the CPU simulation. Furthermore, the display of the hit rate of the instruction cache displayed in FIG. 10 and the message indicating whether the margin for the program execution cycle number of the simulated system and the execution time is small are no longer displayed.

The program execution cycle number (displayed in row ‘CPU: ’) in a case where the memory access penalty is 0 is the difference of the number of cycles totaled as the memory access penalty (displayed in row ‘Memory:’) from the program execution cycle number of the simulated system (displayed in the row ‘System:’).

The configuration of the system simulator 2101 in the system performance evaluation method of the first embodiment will be described next.

FIG. 8 is a block diagram showing the configuration of the system simulator 2101 of the first embodiment. The system simulator 2101 of the first embodiment is a simulator that simulates the operation of the device integration system that comprises a system LSI and so forth. Further, the memory model 2205, CPU model 2204, and execution cycle number counting portion 2203 in FIG. 8 are the same as those of a conventional typical system simulator and a description of these components will be omitted here.

The system simulator 2101 of the first embodiment comprises a memory access alternate processing portion 2120 that performs the memory access simulation instead of the CPU model 2204.

The scheduling portion 2102 controls the execution order and so forth of the CPU model 2204 and memory model 2205 and comprises the CPU cycle number count portion 2110 that counts the CPU cycle number from which the effect of the memory access penalty is removed, the memory access penalty detection portion 2111 that detects the memory access penalty that occurs in the memory model 2205, and an instruction cache hit rate judgment portion 2131 that measures the rate at which the instruction cache is hit in the memory access to the memory model 2205.

The model execution processing step S100 in the system performance evaluation method of the first embodiment will be described next.

The scheduling portion 2102 executes the model execution processing step S100 in accordance with the flow shown in FIG. 1. Further, the memory model execution step S201, CPU model execution step S202, execution cycle number increment step S203, and termination condition judgment step S204 in FIG. 1 are the same as those of the conventional typical system simulator mentioned earlier and a description of these steps is therefore omitted here.

The model execution processing step S100 comprises an instruction cache hit rate judgment processing step S800 that measures the rate at which the instruction cache is hit, a penalty existence judgment step S101 that judges the existence of a memory access penalty, a CPU cycle number increment step S102 that increments the CPU cycle number saved in the CPU cycle number counting portion 2110 shown in FIG. 8, a memory access alternate processing step S300 that executes the memory access alternate processing portion 2120 shown in FIG. 8, and the instruction cache hit rate judgment processing step S400 that displays a message indicating whether the margin with respect to the execution cycle number of the system obtained as the simulation result in accordance with the hit rate of the instruction cache is small.

As shown in FIG. 1, the model execution processing step S100 executes, in parallel with the execution of the memory model execution step S201, the instruction cache hit rate judgment processing step S800, the penalty existence judgment step S101, CPU cycle number increment step S102, and the memory access alternate processing step S300.

The first embodiment is characterized in that the CPU model execution step S202 and memory access alternate processing step S300 are selectively executed in accordance with the result of the penalty existence judgment step S101 and the CPU cycle number increment step S102 is executed only when the CPU model execution step S202 is executed.

The penalty existence judgment step S101 is executed by means of the memory access penalty detection portion 2111 shown in FIG. 8, references the internal state of the memory model 2205, and investigates whether a memory access penalty has occurred. If, as a result of the investigation, a memory access penalty has occurred, it is judged that there is a penalty and, if a memory access penalty has not occurred, it is judged that there is no penalty. However, the penalty existence judgment step S101 judges that there is no penalty irrespective of the occurrence of a memory access penalty when the -s option has not been indicated as an option of the sim command.

When it is judged that there is no penalty in the penalty existence judgment step S101, the CPU model execution step S202 is executed, whereupon the CPU cycle number increment step S102 is executed. Meanwhile, when it is judged that there is a penalty in the penalty existence judgment step S101, the CPU model 2204 executes the memory access alternate processing step S300 without executing the CPU model execution step S202.

According to the control mentioned above, the CPU model execution step S202 performed by the CPU model 2204 shown in FIG. 8 is executed only when a memory access penalty has not occurred and, inevitably, the simulation is performed when the memory access penalty is 0.

Accordingly, the number of times the CPU model 2204 held by the CPU cycle number counting portion 2110 is executed by the CPU cycle number increment step S102 can be the instruction execution time when the memory access penalty is 0. As a result, the CPU performance when the effect of the memory access penalty is removed can be accurately measured.

Furthermore, another characteristic of the first embodiment of the present invention is that the instruction cache hit rate judgment step S400 that displays a message indicating whether the margin with respect to the execution cycle number of the system obtained as the simulation result is small is executed before the model execution termination processing.

By executing the instruction cache hit rate judgment processing step S400 (described subsequently) and communicating whether the margin of the obtained simulation result is small to the user of the system performance evaluation system 1100, the user is able to judge to what extent the value indicating the performance of the whole system can be relied upon. However, the instruction cache hit rate judgment processing step S400 is skipped when option -s has not been designated as the option of the sim command mentioned earlier.

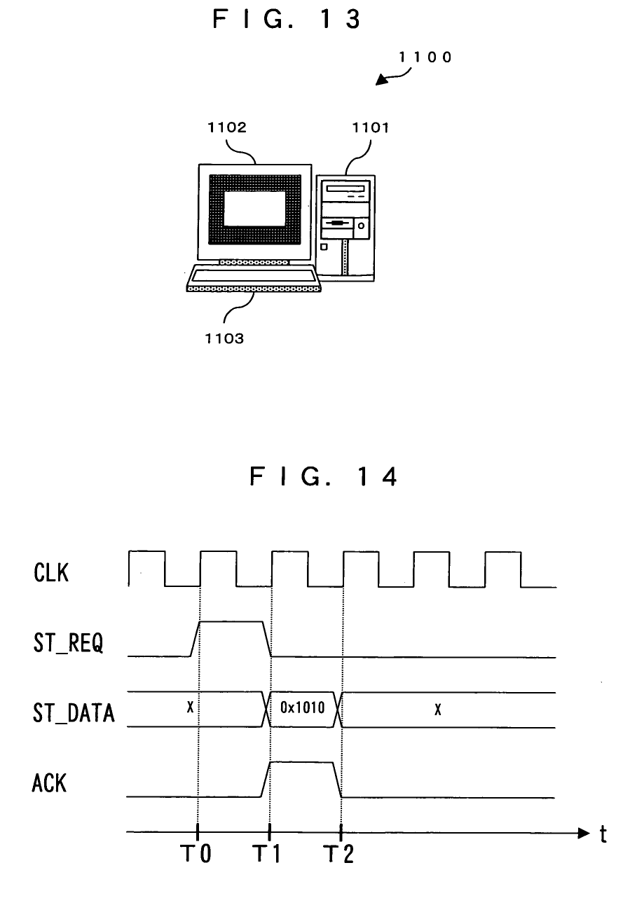

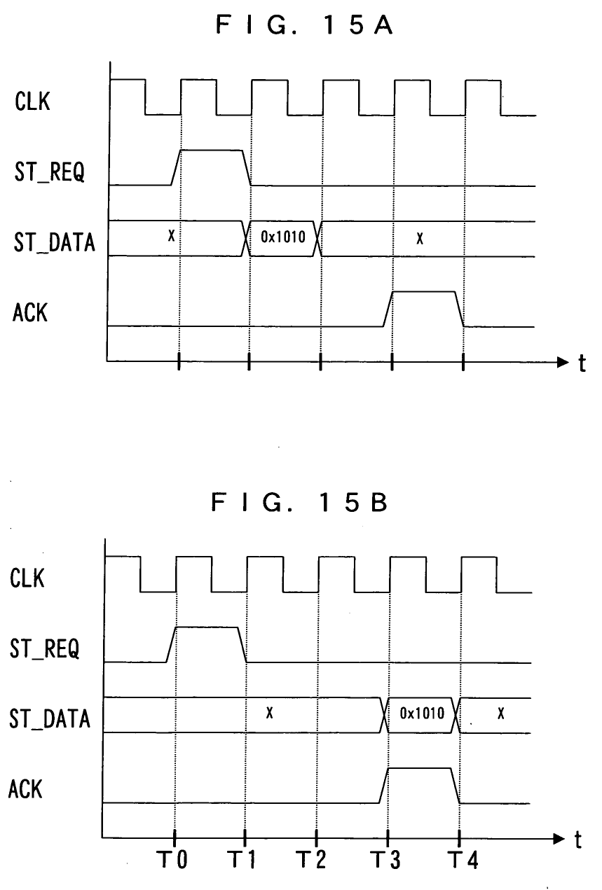

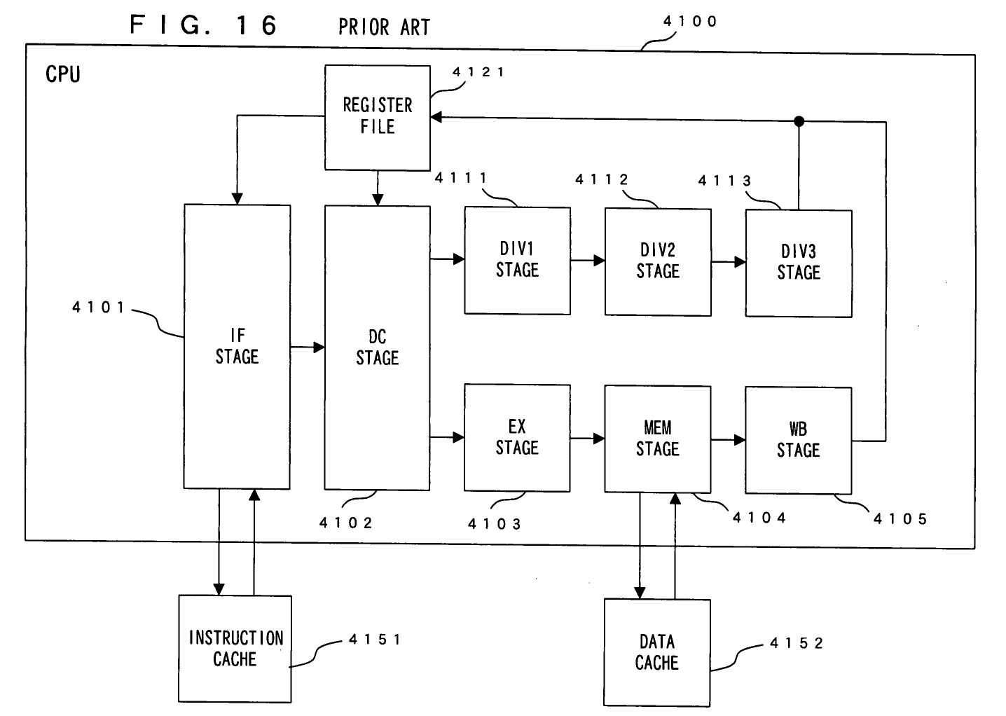

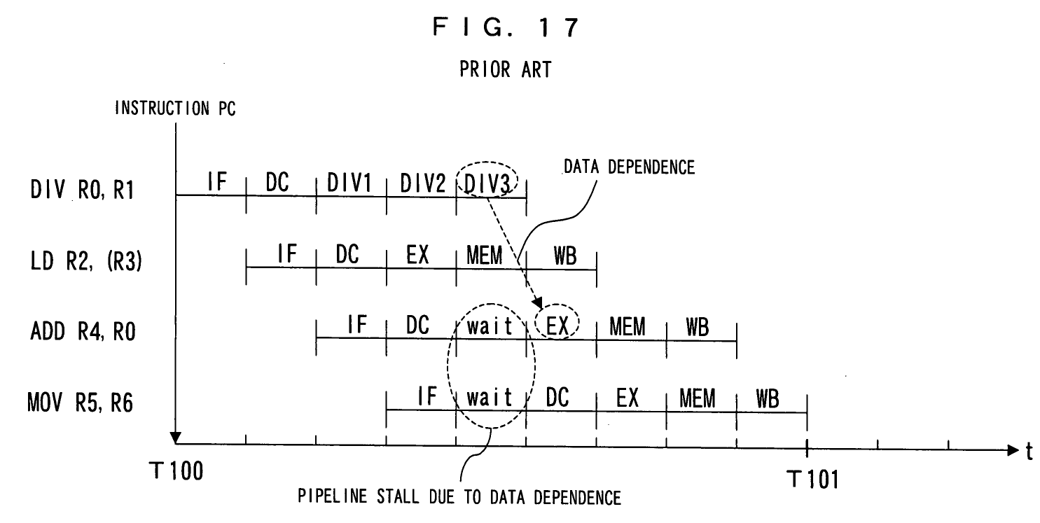

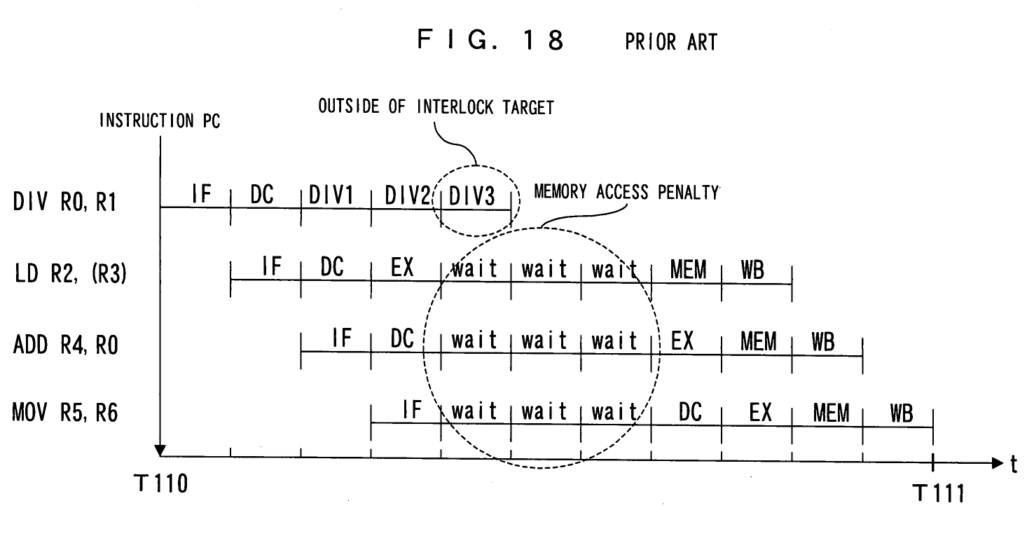

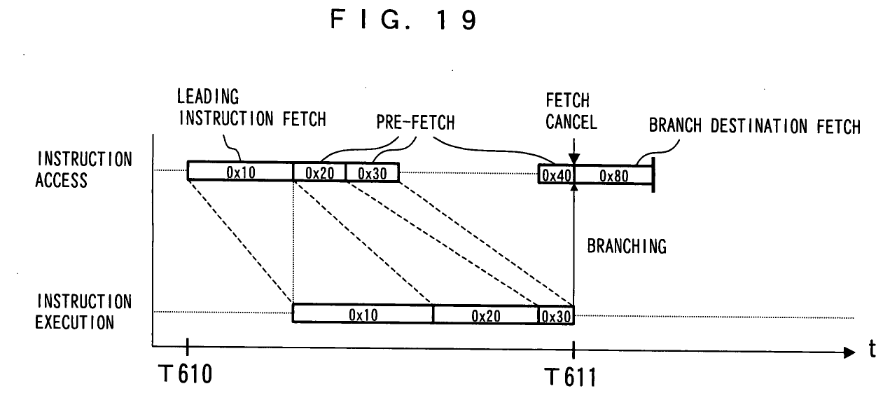

The problem solved by the memory access alternate processing portion 2120 in the system performance evaluation method of the first embodiment will be described next with reference to FIGS. 14, 15A, and 15B.

FIGS. 14, 15A, and 15B are waveform diagrams showing signals that are to be communicated by the CPU model 2204 and the memory model 2205. A variety of signal lines stand in a line on the vertical axis and the horizontal axis represents the time of the simulation of the system. The respective signals lined up on the vertical axis have the following meanings (the correspondence between signals and meanings appears as ‘signal:meaning’ hereinbelow).
CLK: system clock
ST_REQ: store request from CPU model 2204
ST_DATA: store data from CPU model 2204
ACK: request acceptance communication from memory model 2205

In the case of the simulation system of the first embodiment, the CPU model 2204 shown in FIG. 8 is subject to the rule that store data ST_DATA is outputted one cycle after the store request ST_REQ became active. Further, the memory model 2205 shown in FIG. 8 is subject to the rule that the request acceptance communication ACK is made active in the cycle in which the acceptance of the store request ends. In addition, the request acceptance communication ACK is subject to the rule of being an acceptance termination communication with respect to a final request that is issued at least one cycle before or earlier.

FIG. 14 is a signal waveform in a case where the storage of data from the CPU model 2204 shown in FIG. 8 to the memory model 2205 is requested and the memory model 2205 accepts the storage request in one cycle. In this case, the memory access penalty is 0 cycles.

The CPU model 2204 renders the store request ST_REQ active at time TO and outputs the store data ST_DATA at time T1, which is the next cycle. On the other hand, the memory model 2205 renders active the request acceptance communication ACK that indicates that the request from the CPU model 2204 was accepted at T1. The above rule is satisfied by performing the above processing.

FIG. 15A is a signal waveform in a case where a request to store data from the CPU model 2204 to the memory model 2205 is made and the memory model 2205 accepts the store request after three cycles. In this case, the memory access penalty is two cycles.

The CPU model 2204 renders the store request ST_REQ active at time T0 and outputs the store data ST-DATA at time T1, which is the next cycle. On the other hand, the memory model 2205 renders the request acceptance communication ACK, which indicates that the request from the CPU model 2204 has been accepted, active at time T3.

By performing the above processing, the rule is satisfied. Here, the signal waveform in a case where the CPU model 2204 is operated simply only when there is no memory access penalty under the same conditions as FIG. 15A is shown in FIG. 15B. Thus, because the CPU model 2204 is not executed between time T1 and time T3, when the memory access penalty occurs, the store data ST_DATA that was originally to be outputted at time T1 is outputted at time T3 and there is the problem that the rule is not satisfied.

The memory access alternate processing portion 2120 of the first embodiment solves the problem shown above.

According to the method of the first embodiment of the present invention, although the CPU model 2204 is not executed between time T1 and time T3 in FIG. 15A, the memory access alternate processing step S300 is executed instead by the memory access alternate processing portion 2120.

As a result of the memory access alternate processing step S300, store data ST_DATA is outputted to the memory model 2205 at time T1 and the rule can be satisfied.

The memory access alternate processing step S300 in the system performance evaluation method of the first embodiment will be described next.

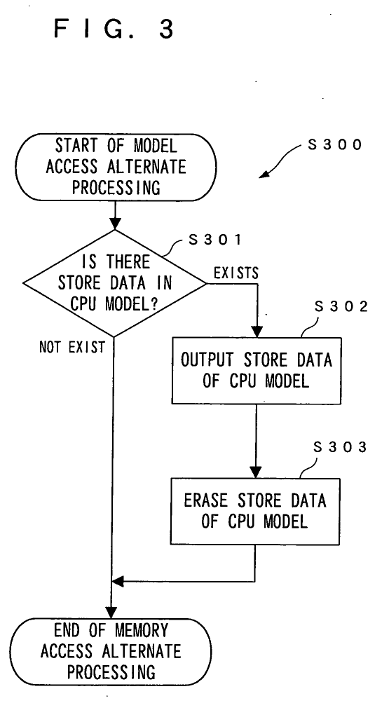

FIG. 3 shows a flowchart of the memory access alternate processing step S300. In order to perform a memory access simulation instead of the CPU model 2204, the memory access alternate processing portion 2120 executes the memory access alternate processing step S300.

The memory access alternate processing step S300 comprises a store data judgment step S301 that judges whether there is store data for the memory model 2205 in the CPU model 2204, a store data output step S302 that outputs store data in the CPU model 2204, and a store data erasure step S303 that erases store data in the CPU model 2204.

The memory access alternate processing step S300 judges whether there is store data in the CPU model 2204 in the store data judgment step S301 and, when there is store data, executes the store data output step S302 and store data erasure step S303. When there is no store data, no steps are executed.

By adopting such a configuration, a memory access penalty is detected when the CPU model 2204 outputs a store request and, because the CPU model 2204 is no longer executed while a penalty occurs and the memory access alternate processing portion 2120 outputs store data in the CPU model 2204, the signal waveform shown in FIG. 15A can be saved and the rule between the CPU model 2204 and memory model 2205 can be satisfied.

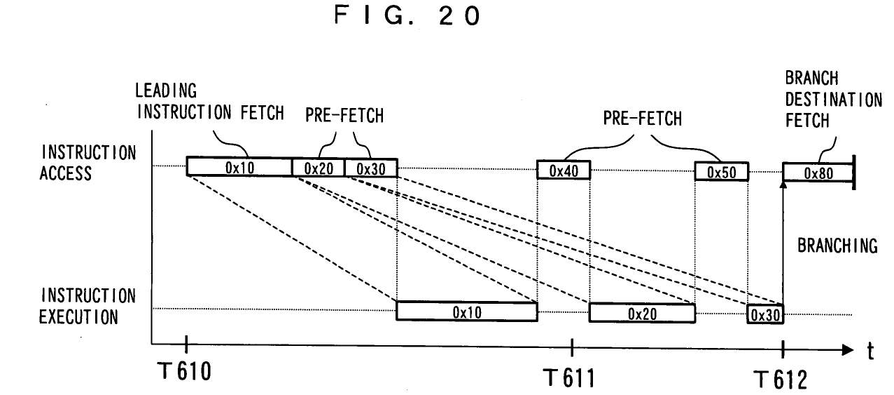

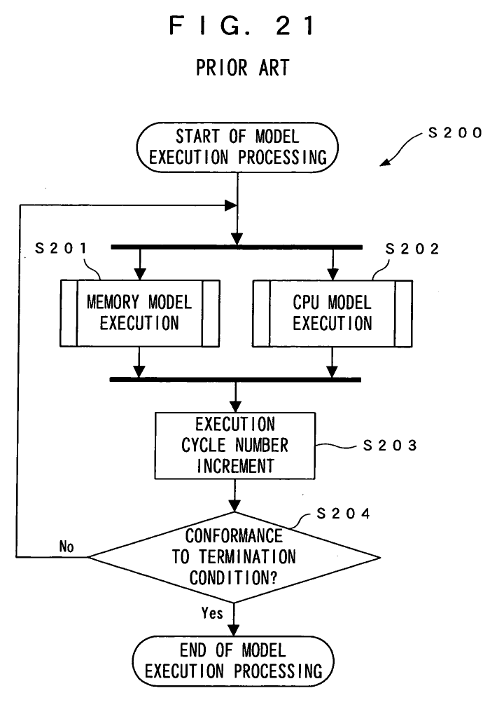

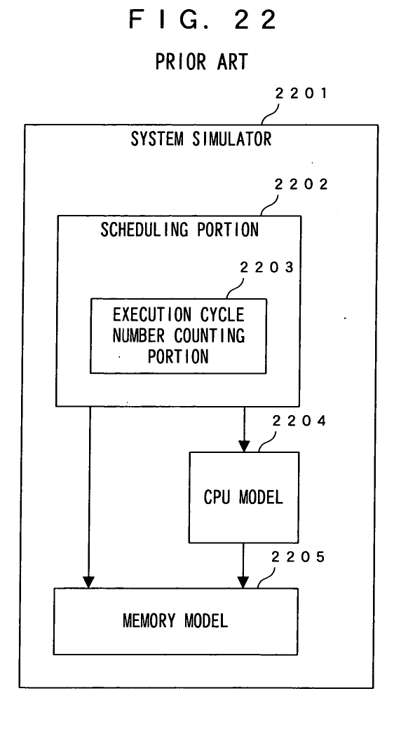

The problems resolved by the instruction cache hit rate judgment processing step S400 in the system performance evaluation method of the first embodiment will be described next by using FIGS. 19 and 20.

FIGS. 19 and 20 are time charts that represent the times of instruction access of the system simulation and the times of instruction execution. On the vertical axis, the two elements of instruction access and instruction execution stand in a line and the horizontal axis represents the time of the simulation. The square waveforms drawn on the instruction access axis show the fetches of instructions to the memory addresses written inside the waveform. The square waveforms drawn on the instruction execution axis show the execution of instructions of the memory addresses drawn inside the square waveform. The broken lines that extend from the square waveforms on the instruction access axis to the square waveforms on the instruction execution axis show correspondence between the fetched instructions and the executed instructions.

FIG. 19 shows the relationship between instruction access and instruction execution when -s is not designated as the option of the sim command, that is, when the effect of the memory access penalty is reflected in the CPU simulation, of the first embodiment.

The instruction access shown in FIG. 19 involves sequential access to the instructions of the memory addresses 0x10, 0x20, 0x30, 0x40, and 0x80. Access to the memory address 0x10 is an instruction fetch in a state where the instruction does not exist in the instruction buffer of the CPU and constitutes a leading instruction fetch.

Access to the memory addresses 0x20 to 0x40 is instruction access that is performed in the background where the CPU executes instructions and constitutes a pre-fetch. Access to the memory address 0x40 in FIG. 19 indicates that a branch line instruction is executed before the instruction fetch ends, a fetch cancel occurs, and the instruction fetch is interrupted at a midway point. The memory address 0x80 is a branch line instruction fetch, which is a branch line fetch.

The state shown in FIG. 19 executes the CPU model 2204 irrespective of the occurrence of the memory access penalty and, therefore, instruction access and instruction execution are performed in parallel. The time from the start of the fetch of the instruction of memory address 0x10 in the state shown in FIG. 19 until execution of the branch line instruction is from time T610 until time T611.

FIG. 20 shows the relationship between instruction access and instruction execution when -s is designated as an option of the sim command, that is, when the effect of the memory access penalty is reflected in the CPU simulation, of the first embodiment.

With the instruction access shown in FIG. 20, the same instructions as those of FIG. 19 are fetched in the same order. However, in the state shown in FIG. 20, the CPU model 2204 is not executed when a memory access penalty occurs and, therefore, instruction access and instruction execution are performed exclusively. Accordingly, the time from the start of the fetch of the instruction of the memory address 0x10 in the state shown in FIG. 20 until execution of the branch instruction is time T610 until time T612.

As described hereinabove, the difference comes out in the system execution time whether or not the CPU model 2204 is executed when a memory access penalty occurs. As a result of the difference, there is the problem that the user of the system performance evaluation system 1100 undervalues the performance of the system. In order to resolve the problem, according to the first aspect of this embodiment, the instruction cache hit rate judgment processing step S400 is executed.

The instruction cache hit rate judgment processing step S400 in the system performance evaluation method of the first embodiment will be described next.

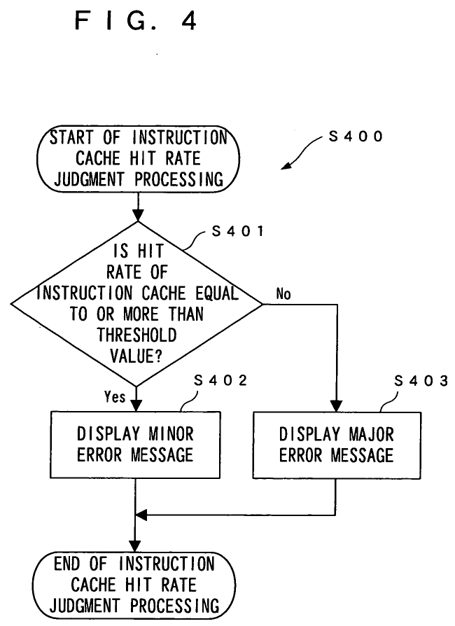

The scheduling portion 2102 shown in FIG. 8 implements the instruction cache hit rate judgment processing step S400 and the internal flow of the instruction cache hit rate judgment processing step S400 is shown in FIG. 4.

The instruction cache hit rate judgment processing step S400 comprises a cache hit rate comparison step S401 of judging whether or not the hit rate of the instruction cache is equal to or more than a threshold value set beforehand, a minor error message display step S402 of displaying a message to the effect that the margin with respect to the program execution cycle number of the simulated system and the execution time is small, and a major error message display step S403 that displays a message to the effect that the margin with respect to the program execution cycle number of the simulated system and the execution time is large.

The instruction cache hit rate judgment processing step S400 executes the minor error message display step S402 when the hit rate of the instruction cache is equal to or more than a threshold value set beforehand as a result of the cache hit rate comparison step S401 and executes the major error message display step S403 when the hit rate of the instruction cache is less than the threshold value set beforehand.

As a result, a message indicating whether or not the margin with respect to the program execution cycle number of the simulated system and the execution time is small can be displayed.

Here, it is explained that, when the hit rate of the instruction cache is high, this is because the error with respect to the program execution cycle number of the simulated system and the execution time is small or the margin is small.

When the hit rate of the instruction cache is high, almost all instruction access is completed in a state where the memory access penalty is 0. When the memory access penalty of instruction access is 0, the memory access penalty of the instruction pre-fetch that is concealed by the time for executing instructions saved in the CPU instruction buffer is 0 and, therefore, there is no difference in the result depending on whether or not the effect of the memory access penalty is substantially reflected in the CPU simulation.

Furthermore, the memory access penalty when the instruction cache is missed is very large in comparison with the time for executing the instruction saved in the instruction buffer of the CPU. Consequently, when the instruction cache is missed, the memory access penalty of the instruction pre-fetch concealed by the time for executing the instruction that is saved in the instruction buffer of the CPU is relatively small. It may therefore be said that the difference in the result depending on whether the effect of the memory access penalty is substantially reflected in the CPU simulation is relatively small.

The instruction cache hit rate judgment processing step S800 in the system performance evaluation method of the first embodiment will be described next.

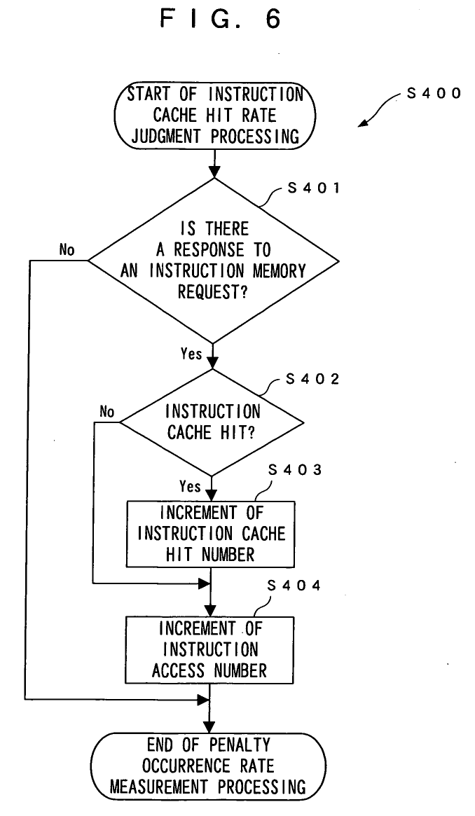

FIG. 6 shows the internal flow of the instruction cache hit rate judgment processing step S800 that is executed in order to measure the instruction cache hit rate in the instruction cache hit rate measurement portion 2131 shown in FIG. 8.

The instruction cache hit rate judgment processing step S800 comprises a response judgment step S401 of judging whether or not there is a response to the instruction memory request from the memory model 2205, a hit judgment step S402 of judging whether or not the instruction cache has been hit with respect to the instruction memory request, a hit number increment step S403 of incrementing the instruction cache hit number, and an instruction access number increment step S404 of incrementing the instruction access number.

The instruction cache hit rate judgment processing step S800 executes the instruction access number increment step S404 when there is a response to the instruction memory request in the response judgment step S401 and when the instruction cache is not hit in the hit judgment step S402. Further, the instruction cache hit rate judgment processing step S800 carries out a hit number increment step S403 when there is a response to the instruction memory request in the response judgment step S401 and the instruction cache is hit in the hit judgment step S402.

According to such a method, the instruction access number is incremented whenever there is a response to an instruction memory request and the instruction access number is counted. Further, the instruction cache hit number is incremented whenever the instruction cache is hit and the instruction cache hit number is counted. Accordingly, the quotient rendered by dividing the instruction cache hit number by the instruction access number can be calculated as the instruction cache hit number.

As detailed hereinabove, with this embodiment, it is possible to specify whether or not the memory access penalty is reflected in the CPU simulation by using the option -s of the sim command during execution of the system simulator 1101.

Further, supposing that the memory access penalty is not reflected in the CPU simulation, because the configuration is such that the CPU model 2204 is not executed when the memory access penalty occurs by means of the model execution processing step S100 that is executed by the scheduling portion 2102, the execution cycle number when the effect of the memory access penalty on the CPU simulation is removed can be accurately measured.

In addition, because the instruction cache hit rate judgment processing step S400 is included, a message with regard to the size of the margin of the system performance in a state where instruction access and instruction execution are executed exclusively can be displayed.

### Second Embodiment

The system performance evaluation method of the second embodiment of the present invention will now be described. Further, in the second embodiment, although the index for estimating the size of the margin of the system performance of the simulation that is executed at the time of the system performance evaluation of the first embodiment is the instruction cache hit rate, a case where the index is the occurrence rate of the instruction memory access penalty will be described. The majority of the configuration is the same as that of the case of the first embodiment and, in order to simplify the description, the focus of the description will be on the parts that are different between the first and second embodiments.

First, the appearance of the system performance evaluation system relating to the system performance evaluation method of the second embodiment will be described. Further, the appearance of the system performance evaluation system of the second embodiment is the same as that of the system performance evaluation system 1100 of the first embodiment and, therefore, a description thereof is omitted here.

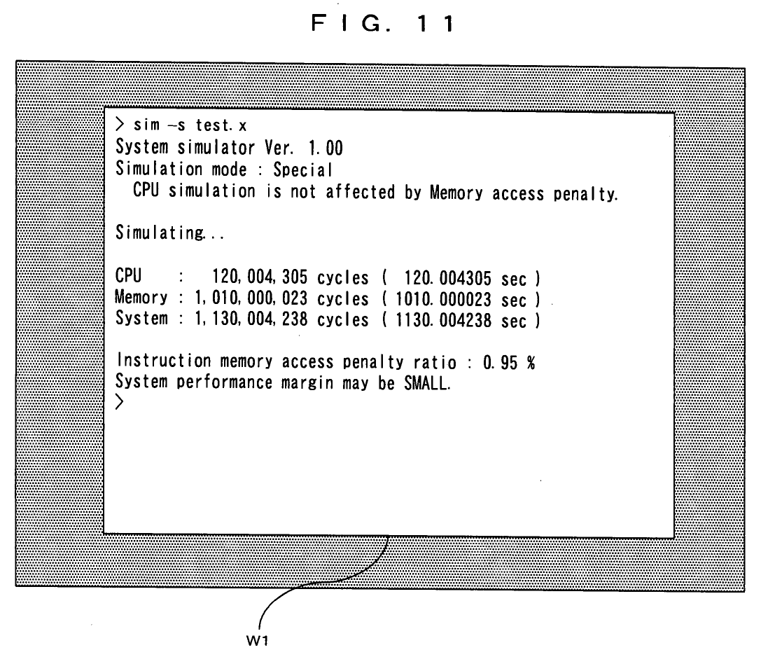

The inputs and outputs to and from the system performance evaluation system relating to the system performance evaluation method of the second embodiment will be described next by using FIGS. 11 and 12. Further, in the description of the inputs and outputs to and from the system performance evaluation system of the second embodiment, parts that are the same as the inputs and outputs to and from the system performance evaluation system of the first embodiment will be omitted here.

FIG. 11 is an input/output example for the system performance evaluation system of the second embodiment that shows the content displayed on the display device of the system performance evaluation system.

The content that is illustrated in FIG. 11 will now be described in detail.

The row ‘Instruction Memory Access Penalty ratio:’ in FIG. 11 shows the occurrence rate of the instruction memory access penalty. FIG. 11 shows that a memory access penalty occurs in 0.95% of the instruction memory access, of the total memory access. In the remainder of the display, the display content is the same as the display content of FIG. 10.

Further, the judgment of whether the margin with respect to the program execution cycle number of the simulated system and the execution time is small is made in a penalty occurrence rate judgment processing step S500 (described subsequently).

Further, the display content when there is no option -s in the sim command shown in FIG. 11 is the same as the display content shown in FIG. 12 illustrated in the first embodiment. As per the first embodiment, the display of the occurrence rate of the instruction memory access penalty displayed in FIG. 11 and the message indicating whether or not the margin with respect to the program execution cycle number of the simulated system and the execution time is small are no longer displayed.

The configuration of the system simulator 2301 in the system performance evaluation method of this embodiment will be described next.

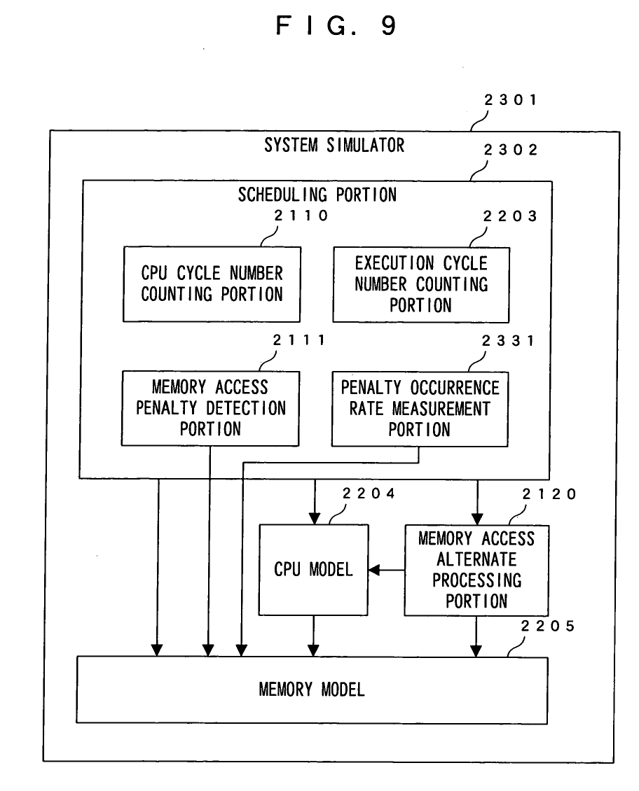

In the system simulator 2301 of the second embodiment shown in FIG. 9, the instruction cache hit rate measurement portion 2131 that is provided in the first embodiment shown in FIG. 8 is replaced with the penalty occurrence rate measurement portion 2331 that measures the access penalty rate of the instruction memory.

A model execution processing step S1000 in the system performance evaluation method of the second embodiment will be described next.

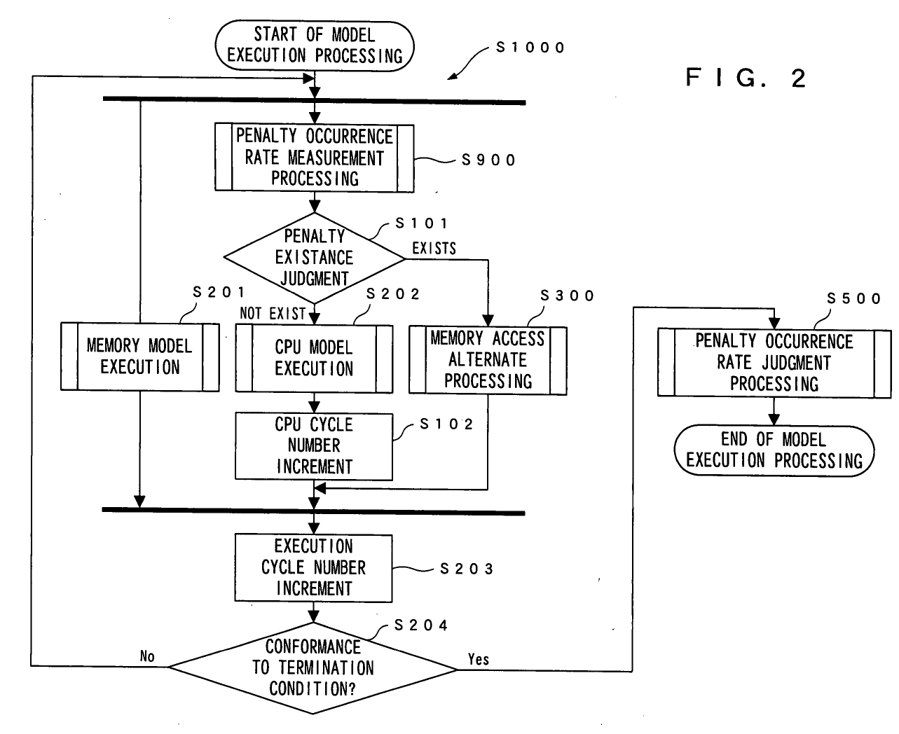

The scheduling portion 2302 executes the model execution processing step S1000 in accordance with the flow shown in FIG. 2. In the model execution processing step S1000, the instruction cache hit rate measurement processing step S800 of the model execution processing step S100 and the instruction cache hit rate judgment processing step S400 shown in FIG. 1 are replaced with a penalty occurrence rate measurement processing step S900 that measures the occurrence rate of the instruction memory access penalty and the penalty occurrence rate judgment processing step S500 that displays a message indicating whether or not the margin with respect to the execution cycle number of the system obtained as the simulation result in accordance with the occurrence rate of the instruction memory access penalty.

The penalty occurrence rate judgment processing step S500 in the system performance evaluation method of the second embodiment will be described next.

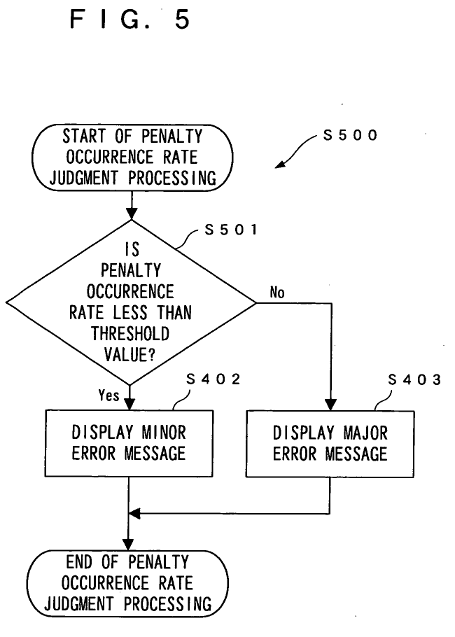

The flow of the penalty occurrence rate judgment processing step S500 is shown in FIG. 5. The penalty occurrence rate judgment processing step S500 shown in FIG. 5 is executed in the scheduling portion 2302 shown in FIG. 9. As shown in FIG. 5, the penalty occurrence rate judgment processing step S500 comprises a penalty occurrence rate comparison step S501 that judges whether or not the instruction memory access penalty occurrence rate is equal to or more than a threshold value that is set beforehand, and a minor error message display step S402 and major error message display step S403 illustrated in the first embodiment.

In the penalty occurrence rate judgment processing step S500 above, when the occurrence rate of the instruction memory access penalty as a result of the penalty occurrence rate comparison step S501 is less than the threshold value set beforehand, the minor error message display step S402 is executed, and, when the hit rate of the instruction cache is equal to or more than the threshold value set beforehand, the major error message display step S403 is executed.

As a result, a message that indicates whether or not the margin with respect to the program execution cycle number of the simulated system and the execution time can be displayed.

Here, it is explained that, when the occurrence rate of the instruction memory access penalty is low, this is because the margin with respect to the program execution cycle number of the simulated system and the execution time is small.

When the occurrence rate of the instruction memory access penalty is low, most of the instruction access is ended in a state where the memory access penalty is 0. That is, it may be said that this is a state that is the same as the case where the instruction cache hit rate is high that was described in the first embodiment.

Accordingly, as per the first embodiment, it may be said that the difference in the result depending on whether or not the effect of the memory access penalty is substantially reflected in the CPU simulation, that is, the margin, is relatively small.

The penalty occurrence rate measurement processing step S900 in the system performance evaluation method of the second embodiment will be described next.

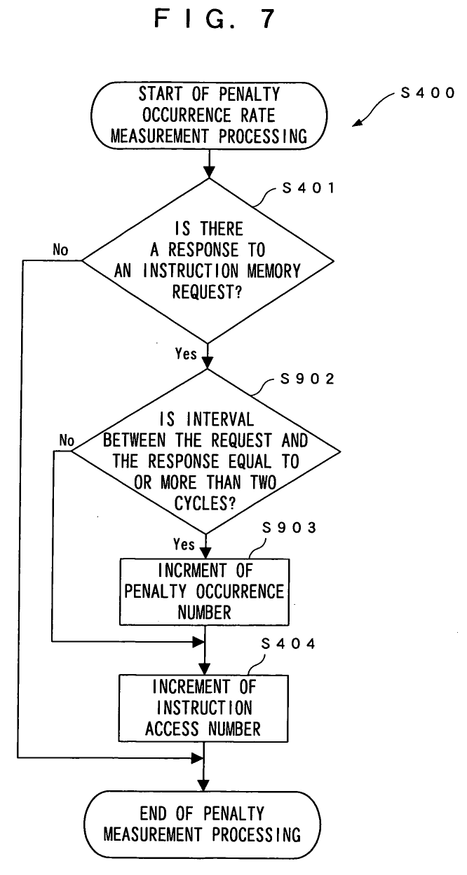

FIG. 7 shows the flow of the penalty occurrence rate measurement processing step S900 that is executed in order to measure the occurrence rate of the instruction memory access penalty in the penalty occurrence rate measurement portion 2331 shown in FIG. 9. As shown in FIG. 7, the penalty occurrence rate measurement processing step S900 comprises the response judgment step S401 described in the first embodiment, the penalty judgment step S902 that judges whether or not the interval between the instruction memory request issued by the CPU model 2204 and the response sent back by the memory model 2205 is equal to or more than two cycles, a penalty occurrence number increment step S903 that increments the penalty occurrence number, and the instruction access number increment step S404 that was described in the first embodiment.

The penalty occurrence rate measurement processing step S900 as mentioned above executes the instruction access number increment step S404 when there is a response to the instruction memory request in the response judgment step S401 and when the instruction memory access penalty does not occur in the penalty judgment step S902.

Further, the penalty occurrence rate measurement processing step S900 executes the penalty number increment step S903 and instruction access number increment step S404 when there is a response to the instruction memory request in the response judgment step S401 and when the instruction memory access penalty occurs in the penalty judgment step S902.

As mentioned above, the instruction access number is incremented whenever there is a response to the instruction memory request and the instruction access number can be counted. Further, the penalty occurrence number is incremented whenever the instruction memory access penalty occurs and the occurrence number of the instruction memory access penalty can be counted. Accordingly, a quotient rendered by dividing the occurrence number of the instruction memory access penalty by the instruction access number can be accurately calculated as the penalty occurrence rate.

As mentioned above, according to the embodiment, an index for estimating the size of the margin of the system performance of the first embodiment can be moved from the instruction cache hit rate to the occurrence rate of the instruction memory access penalty, whereby the same effects as those of the case in the first embodiment can be obtained even when the instruction cache hit rate is not measured.

What is claimed is:

1. A system performance evaluation method for evaluating a performance of a system comprising at least one CPU and memory hierarchy, comprising:
a CPU simulation step of executing a simulation of the CPU;
a memory simulation step of executing a simulation of the memory hierarchy;
a system simulation step of executing the CPU simulation step and the memory simulation step in parallel;
a CPU performance measurement step of measuring the performance of the CPU from which an effect of the memory hierarchy is removed; and
a system performance measurement step of measuring a performance deterioration of the system caused by the effect of the memory hierarchy.

2. The system performance evaluation method according to claim 1, further comprising:
a penalty occurrence judgment step of judging whether or not a memory access penalty has occurred in the memory simulation step; and
a CPU simulation skip step of skipping the CPU simulation step when it is known that a memory access penalty has occurred as a result of the judgment in the penalty occurrence judgment step, wherein
in the CPU performance measurement step, the CPU performance is measured based on the number of cycles in which the CPU simulation is finally executed as a result of skipping the CPU simulation step in the CPU simulation skip step.

3. The system performance evaluation method according to claim 2, further comprising:
a memory access simulation step of executing a simulation of only a memory access in the CPU simulation step; and
a simulation selection step of executing the memory access simulation step when it is known that a memory access penalty has not occurred as a result of the penalty occurrence judgment step.

4. The system performance evaluation method according to claim 3, further comprising:
a simulation mode selection step of specifying whether or not an effect of the memory access penalty is reflected when executing the CPU simulation step.

5. A system performance evaluation method comprising, as a system simulation for evaluating a performance of a system comprising at least one CPU and memory hierarchy, a step of executing a calculation in number of instruction execution cycles on the CPU when an effect of the memory hierarchy is removed, said method comprising:
an instruction cache hit rate judgment step of judging, in accordance with a hit rate value of an instruction cache memory, simulation errors in results of calculation in number of instruction execution cycles on the CPU when an effect of the memory hierarchy is reflected in the calculation results, with respect to the calculation results when the effect of the memory hierarchy is removed; and
an error display step of displaying the simulation error based on the results of the instruction cache hit rate judgment step.

6. A system performance evaluation method comprising, as a system simulation for evaluating a performance of a system comprising at least one CPU and memory hierarchy, a step of executing a calculation in number of instruction execution cycles on the CPU when an effect of the memory hierarchy is removed, said method comprising:
a memory access penalty judgment step of judging, in accordance with a memory access penalty value, simulation errors in results of calculation in number of instruction execution cycles on the CPU when an effect of the memory hierarchy is reflected in the calculation results, with respect to the calculation results when the effect of the memory hierarchy is removed; and
an error display step of displaying the simulation error based on the results of the instruction cache hit rate judgment step.
